(19) United States
(12) Patent Application Publication
(10) Pub. No.: US 2011/0249465 A1
(43) Pub. Date: Oct. 13, 2011

(54) Directional safety mirror "flasher"

(76) Inventor: Joshua S. McCourt, Oak Harbor, WA (US)

(21) Appl. No.: 12/931,872

(22) Filed: Feb. 14, 2011

Related U.S. Application Data
(60) Provisional application No. 61/339,205, filed on Mar. 2, 2010.

(51) Int. Cl. B60Q 1/38

(52) U.S. Cl. 362/540

(57) ABSTRACT

The Directional Safety Mirror, “Flasher” unit has been designed for mounting on a commercial vehicle such as a heavy haul truck, commercial truck, or buses. An additional side view mirror assembly for security to each side of an associated commercial vehicle.

The mirror assembly includes thirty eight red colored light emitting diode (LED) bulbs lined in a double chevron “>>” shape; in which the double chevron alternates between one chevron to the other chevron indicating the direction that said vehicle is intending to turn. The Directional Safety Mirror assembly of light emitting diodes (LED) bulbs projects through the mirrored glass wherein an illumination is in electrical communication on said vehicle it is installed upon with the turning signals and emergency circuitry of an associated commercial vehicle or bus. The mirror is capable of movement about both a vertical and a horizontal axis. The directional mirror can be attached to an already existing bracket on said commercial vehicles or buses.

### CROSS-REFERENCE TO RELATED APPLICATIONS

This application claim the benefit of provisional patent application Ser. No. 61/339,205, filed 2010 Mar. 2 by the present inventor.

### FEDERALLY SPONSORED RESEARCH

Not Applicable

### SEQUENCE LISTING OR PROGRAM

Not Applicable

### BACKGROUND

### Field

The invention relates generally to mirrors for commercial vehicles. More particularly, the present invention relates to the circular convex mirror unit for a commercial vehicle such as a heavy haul truck or a bus.

Commercial vehicular operation in present congested driving environments requires an enhanced degree of caution and indication of intended vehicular direction in an effort to provide an enhanced indication to the other motor vehicle operators of intended vehicular direction of an associated motor vehicle by a driver there-within. The instant invention attempts to provide an initial degree of safety in the operation of a commercial vehicle by including directional indication organization within said mirrors for use by a commercial vehicle operator. The side mirror structure permits a driver of the associated vehicle to visually appreciate positioning of other motor vehicles and accordingly provides an enhanced element of safety by permitting indication to such other vehicles of intended direction of the commercial vehicle. Examples of the prior art structure in association with side mirror organization may be found in U.S. Pat. No. 1,904,300 to Cannon wherein structure utilizes a framework with an underling mirror and an overlying housing including a right and left turn signal compartment wherein the organization is a relatively elaborate and expansive organization as opposed to the compact unitary organization as opposed to the compact unitary organization as set forth by the instant invention to minimize impedance of vision by an operator while utilizing the turn signal structure of the instant invention.

U.S. Pat. No. 3,522,584 to Talbot sets forth a side mirror organization that may actually utilize illumination member there-within for illumination of the housing upon opening of a door of an associated automobile.

U.S. Pat. No. 4,646,210 sets forth a vehicular rear view mirror for interiorly of a vehicular compartment with various light members there-within for lighting of various internal portions of the interior automotive environment.

U.S. Pat. No. 2,012,593 to Strong sets forth an interior lamp for use b automobiles wherein the lamp is pivotally mounted to the rear view mirror structure mounted within an interior compartment of an associated motor vehicle.

U.S. Pat. No. 4,807,096 to Skogler sets forth an interior light module for use with a rear view mirror of an automobile mounted interiorly of the vehicular compartment to affect various lighting of interior portions of the automobile and operative by selective switching mounted within the rear view mirror.

All previous inventions stated above are inventions for automobiles. This instant invention is for commercial vehicles, buses. As such, it may be appreciated that there continues to be a need for a new and improved vehicular signal mirror organization as set forth by the instant invention which addresses both the problems of ease as well as effectiveness in construction and in this respect, the instant invention substantially fulfills this need.

### SUMMARY

In view of the foregoing disadvantages inherent in the known types of side view mirror construction present in the prior art, the present invention provides a new and improved commercial vehicle signal mirror organization wherein the same utilizes a turn signal organization in cooperation with a side mirror construction for enhanced operability and safety in operation of an associated commercial vehicle. As such, the general purpose of the present invention, which will be described subsequently in greater detail, is to provide a new and improved vehicular signal mirror organization which has all the advantages of the prior art side view mirror structure and none of the disadvantages.

To attain this, the commercial vehicle signal mirror organization of the instant invention includes apparatus wherein side mirror organization of the instant invention includes apparatus wherein side mirror construction for securement to each side of an associated vehicle: Red colored Light Emitting Diode (LED) bulbs fashioned in a “>>” Double Chevron shape mounted inside of the associated mirror housing; projecting illumination “>>” Chevron shape through mirrored glass.

The light emitting diode (LED) bulbs of the said mirror are electronic communication with the signal and emergency circuitry of an associated commercial vehicle. The said apparatus alternates between two chevron shaped signals “>>” containing thirty eight light emitting diodes (LED) in said direction of vehicles intended direction.

There has thus been outlined, rather broadly, the more important features of the invention in order that the details description thereof that follows may be better understood, and in order that the present contribution to the art may be better appreciated. There are, of course, additional features of the invention that will be described hereinafter and which will form the subject matter of the claims appended hereto.

It is therefore an object of the present invention to provide a new commercial vehicle signal mirror organization which has all the advantages of the prior art side view mirror structure and none of the disadvantages.

It is another object of the present invention to provide a new and improved commercial vehicular signal mirror apparatus which may be easily and efficiently manufactured and marketed.

It is another object of the present invention to provide a new and improved commercial vehicular signal mirror apparatus that will enhance the safety of other vehicles on the road by giving a better indication as to the commercial vehicles intentions.

It is a further object of the present invention to provide a new and improved commercial vehicular signal mirror apparatus which is of a durable and reliable construction.

An even further object of the present invention is to provide a new and improved commercial vehicular signal mirror apparatus which is susceptible of a low cost of manufacture with regard to both materials and labor, and which accordingly is then making such vehicular signal mirror apparatus economically available to the buying public.

Still yet another object of the present invention is to provide a new and improved commercial vehicular signal mirror apparatus which provides in the apparatuses methods of the prior are some of the advantages thereof, while simultaneously overcoming some of the disadvantages normally associated therewith.

### BRIEF DESCRIPTION OF DRAWINGS

The present invention will be more fully understood by reference to the following detailed description of the preferred embodiments of the present invention when read in conjunction with the accompanying drawing, in which like reference characters refer to like parts throughout the views, and in which;

FIG. 1 is a multiple perspective mounting views of a mirror according to the present invention fixed to a commercial vehicle;

FIG. 2 is a horizontal side view of said invention;

FIG. 3 is a front side and back side view of said invention;

FIG. 4 is an exploded perspective view of the mirror assembly;

FIG. 5 is a front and side view of internal turn signal light assembly FIG. 6 is schematic of electrical wiring of light emitting diode board FIG. 7 list of perspective parts used for circuitry on light emitting diode board

### LIST OF REFERENCE NUMERALS

1. Rubber mirror seal
2. Mirror with surface, with translucent chevron shaped holes made enables light emitting diodes (LED) bulbs to shine through
3. Light emitting diode board. Light emitting diodes (LED) on electrical circuit board are shaped in chevrons to coincide translucent areas on mirror surface
4. Electrical wiring connecting light emitting diode (LED) board with individual vehicle
5. Stub ball housing
6. Stud ball
7. Mirror housing
8. Stud ball housing screws
9. Rubber wire protector
10. Washer
11. Bolt for mounting on truck bracket
12. Non-reflective circular areas
13. Example picture of mirror

### DETAILED DESCRIPTION OF THE PREFERRED EMBODIMENT OF THE PRESENT INVENTION

The drawing discloses the preferred embodiment of the present invention. While the configuration according to the illustrated embodiments preferred, it is envisioned that alternate configurations of the present invention may be adopted without deviating from the invention portrayed. The preferred embodiment is discussed hereafter.

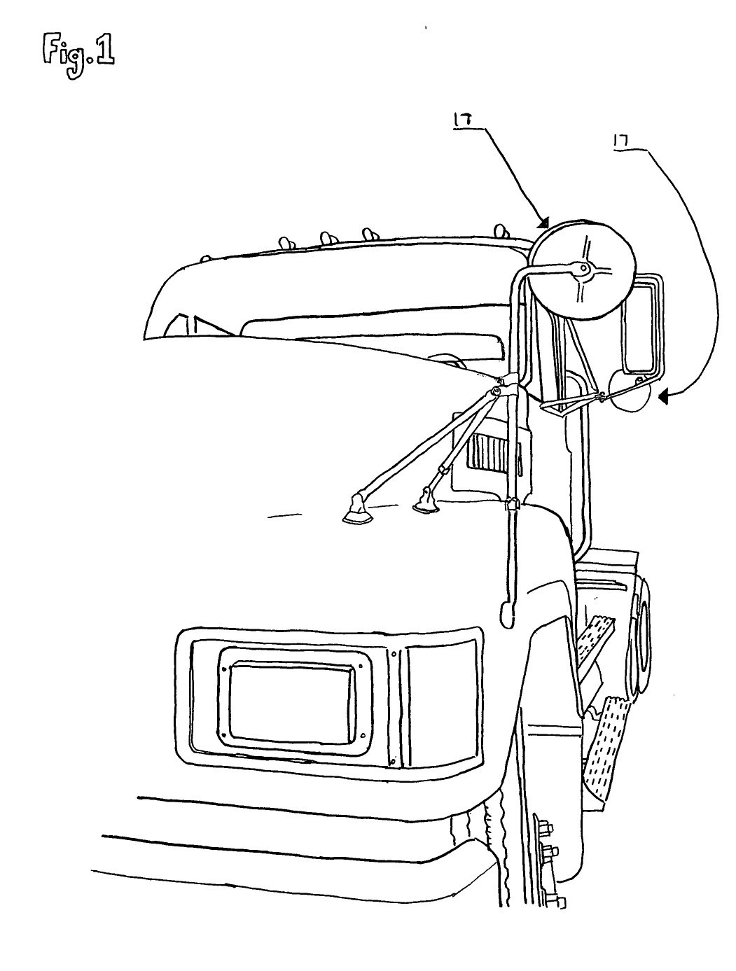

Referring to FIG. 1, multiple mirror units according to the present invention is shown and is generally indicated as (13). The mirror unit (13) includes a mirror housing (6) and a mirror (2). The housing (6) may be composed of metal. The mirror unit (13) may be attached to any existing bracket as in FIG. 1.

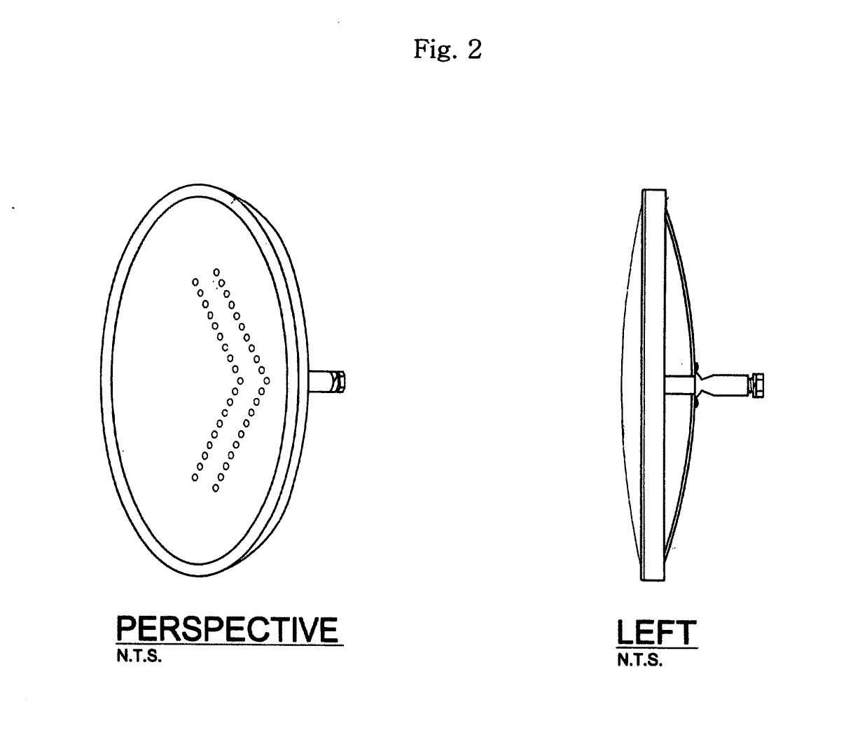

Referring to FIG. 2, the mirror portion (2) and housing comprise a mirror assembly collectively indicated as FIG. 2. The mirror assembly is attached to a commercial vehicle as in FIG. 1, such as a truck or a bus, by existing brackets. Although a pair of brackets is illustrated in FIG. 1, other support structures having alternate configurations are applicable.

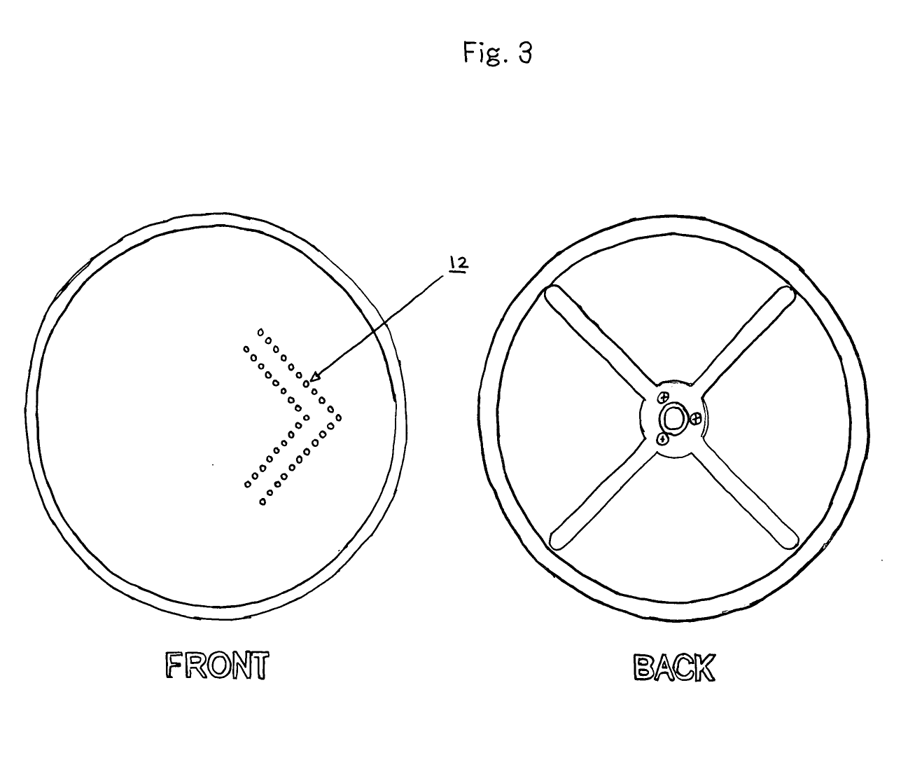

With reference to FIG. 3, the mirror portion (2) as illustrated is substantially planar. On mirror portion (2), has a non-reflective circular area (12). On mirror portion (2), the non-reflective circular areas (12) are fashioned in a double chevron “>>” shape to one edge of mirror portion in FIG. 3.

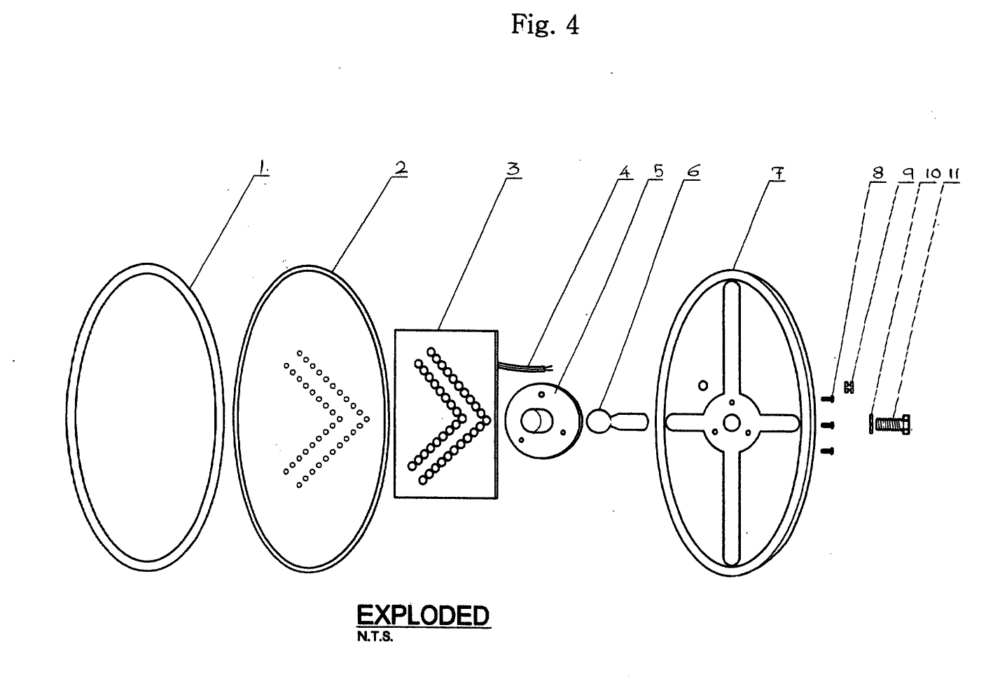

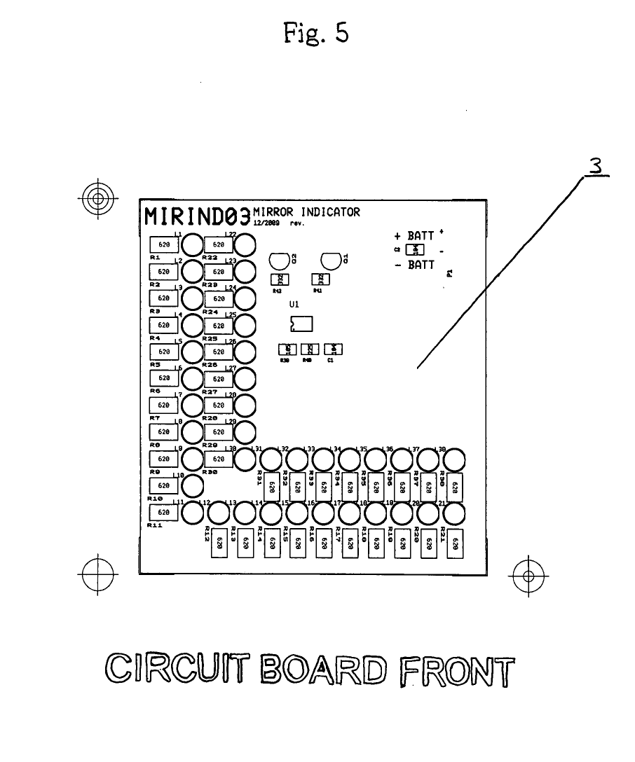

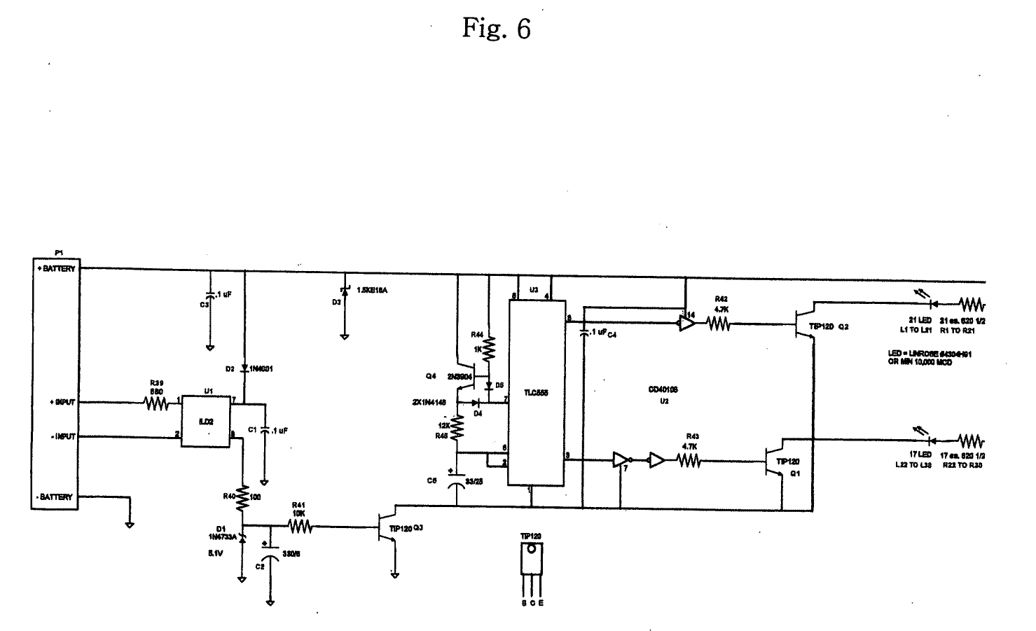

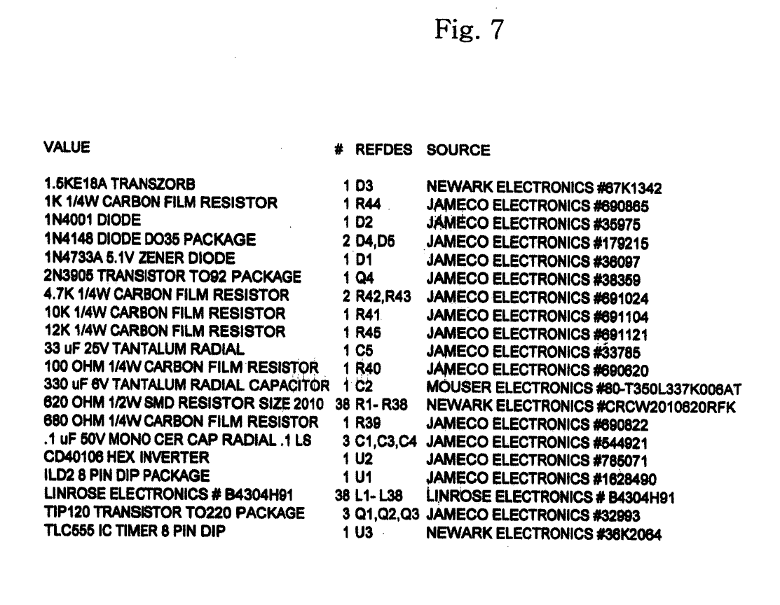

Referring to FIG. 4, an exploded perspective view of the mirror assembly, generally indicated as 13 as in FIG. 1, the assembly includes the mirror housing (7), stud (6) and bolt (11), is used to attach to a commercial vehicle. Stud ball housing (5) whereby said mirror assembly is pivotal about both a vertical axis and a horizontal axis. Stud ball housing (5) is attached to mirror housing (7) with screws (8).

As may be readily understood from this view, the mirror assembly includes light emitting diode board with red colored translucent light emitting diode (LED) lenses (3). The light emitting diode board is in electrical communication with vehicle with wire (4). The electrical wire (4) is placed through hole in mirror housing (7) and protected from scraps, nicks or damage from rubber wire protector (9). Light emitting diode board (3) is attached to mirror housing (7) and is held in place with silicone adhesive to mirror (2). Electrical emitting diode (LED) board (3) is in electrical communication with the turning signals and emergency circuitry of an associated commercial vehicle.

I claim:

1. A mirror apparatus is filled with light emitting diodes (LED) in a double chevron “>>” shape between mirror and mirror frame.

2. Turn signal frequency is obtained from existing commercial vehicle, this signal then alternates between each chevron “>>” shaped light emitting diodes (LED).
